(19) United States
(12) Patent Application Publication
(10) Pub. No.: US 2007/0029168 A1
(43) Pub. Date: Feb. 8, 2007

(54) Grease and oil skimmer and method of use thereof

(76) Inventor: Greg Lane, Horatio, AR (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/195,034

(22) Filed: Aug. 2, 2005

(51) Int. Cl. B65G 45/00

(52) U.S. Cl. 198/497

(57) ABSTRACT

A grease and oil skimmer comprising externally and internally disposed scrapers and catch/collection pans and troughs that remove and collect oil, or the like, from the exterior and underside surfaces of an endless belt cooperatively-engaged over a motorized drive roller, idler roller and offset roller. The drive roller, idler roller and offset roller, provide structural enhancements that cooperatively function to limit surface-to-surface contact between the rollers and the underside of the belt; thereby, effectively reducing overall belt wear, and the transfer of oils and the like from the belt underside to the rollers. The present invention further provides a belt tension adjuster, loss of motor power alerts, and, in an alternate embodiment, adjustable spring-loaded scrapers.

### TECHNICAL FIELD

The present invention relates generally to liquid separation machines, and more specifically to a grease and oil skimmer and method of use thereof. The present invention finds particular application in recovering or removing grease, fats, oils, and other suspended solids, from animal processing wastewater.

### BACKGROUND OF THE INVENTION

The animal processing industry has historically been, and remains, under significant federal and state regulatory scrutiny with respect to the various procedures utilized to process and prepare food products from cattle, hogs, chicken, fish, and other animals. In particular, food and environmental regulatory agencies are often concerned with, and thus frequently monitor or police, the wastewater containment and treatment practices of animal processing facilities.

For instance, in broiler chicken processing plants, substantial quantities of water are commonly utilized in scald tank and chill tank preparations, and to rinse clean processed chicken carcasses, as well as processing equipment. As such, wastewater, heavily laden with chicken fat, grease, oil, and solid particulate, produced from such processing plants, must be properly contained and treated in compliance with government food and environmental regulatory policies.

Accordingly, most such regulatory agencies require animal processing facilities to coordinate delivery of contained wastewater to local municipal water treatment plants. Unfortunately, however, the regular receipt and processing of wastewater by a treatment plant can impose a significant resource burden on the plant, which effectively translates to an immediate expense incurred by the animal processing facility. Consequently, to avoid the financial burden exacted through such regulatory compliance, many animal processing facilities will resort to discharging the wastewater directly into receiving streams or ground soil, a disruptive measure that runs counterintuitive to the very essence of such regulatory polices—maintenance of environmental equilbria.

In an attempt to provide a relatively cost-effective alternative to water treatment plants, the environmental engineering industry has introduced a wide array of belt-type skimmers that may be utilized to separate oil and grease from animal processing wastewater. With such skimmers, an endless belt is typically cooperatively-engaged or passed around a motorized drive roller (or pulley) and an idler roller, wherein the idler roller is positioned within the containment or body of wastewater. Actuation of the drive roller results in a descending reach of the belt entering the body of wastewater, wherein the belt picks up surface oil, or the like, and carries the oil around the idler roller to an ascending reach of the belt. A scraping edge or wiper in contact pressure with belt, and typically positioned near the top of the descending reach of the belt (i.e., opposite the direction of rotation of the belt), scrapes or removes the oil from the surface of the belt, channeling the removed oil into collection pans for appropriate containment, disposal and/or processing.

Although such belt-type skimmers provide a convenient method for processing of wastewater, most possess structural and functional design flaws that render application of the skimmers largely inefficient, and that impose costly maintenance requirements. For instance, with most available skimmers, the underside of the belt resides in full contact with the drive roller and idler roller, which, unfortunately, results in premature wear of the belt and, thus, frequent replacement of same. Additionally, with such full contact belt-roller arrangements, oil transfer from the belt underside to the rollers is increased, resulting in slippage and/or misalignment of the belt over the rollers; thus, further contributing to premature wear of the belt, and effecting overall efficiency of the separation process.

Furthermore, skimmers of the foregoing design typically only comprise wipers in pressure contact with the exterior of belt, but fail to provide wipers in pressure contact with the underside of the belt or, at the very minimum, an internal catch pan to collect oil dripping from the underside of the belt as it rounds or passes over the drive roller. Consequently, oil disposed on the underside of the belt is reintroduced back into the body of wastewater; thus, further retarding the overall separation process.

Therefore, it is readily apparent that there is a need for a belt-type grease and oil skimmer that fully and effectively removes oil, grease, and the like, from both the exterior and underside surfaces of the belt; thereby, preventing reintroduction of such oils and grease back into the body of wastewater. There is a further need for such a skimmer that provides an internal catch pan, in combination with an internal scraper, to collect oils and the like dripping from the belt as the belt rounds or passes over the drive roller; thereby, further preventing reintroduction or drippage of such oils back into the body of wastewater. There is still a further need for such a skimmer that limits belt-to-roller contact and, thus, minimizes oil transfer therebetween, as well as belt wear.

### BRIEF SUMMARY OF THE INVENTION

Briefly described, in a preferred embodiment, the present invention overcomes the above-mentioned disadvantages, and meets the recognized need for such an invention by providing a grease and oil skimmer comprising externally and internally disposed scrapers and catch/collection pans and troughs that remove and collect oil, or the like, from the exterior and underside (interior) surfaces of an endless belt cooperatively-engaged over a motorized drive roller, idler roller and offset roller. The drive roller, idler roller and offset roller, provide structural enhancements that cooperatively function to limit surface-to-surface contact between the rollers and the underside of the belt; thereby, effectively reducing overall belt wear, and the transfer of oils and the like from the belt underside to the rollers. The present invention further provides a belt tension adjuster, loss of motor power alerts, and, in an alternate embodiment, adjustable spring-loaded scrapers.

According to its major aspects and broadly stated, the present invention in its preferred form is a grease and oil skimmer comprising an endless belt, motorized drive roller, idler roller, offset roller, scraper assembly, catch pan, collection troughs, and discharge tube.

More specifically, the present invention is a grease and oil skimmer, wherein an endless belt is cooperatively-engaged over and around an upper motorized drive roller, a middle offset roller, and a lower idler roller. Preferably formed around each roller is a series of raised rings or spacers that provide the only contact surfaces between each roller and the underside of the belt; thus, minimizing belt wear.

Preferably, an arrangement of inner and outer ascending and descending belt scrapers collectively function to scrape and remove oil, grease, fat and solid particulate (i.e., waste) from the exterior and underside surfaces of the belt during operation. Preferably, all waste removed from the belt is received by, or deposited into, an arrangement of inner and outer catch/collection pans and troughs, wherein such waste is subsequently channeled into a common drainage assembly for appropriate handling and/or disposal.

As normal belt wear is expected, the present invention further contemplates the application of a belt tension adjuster, which may be utilized until replacement of the belt becomes necessary. Additionally, should there be a loss of power to the drive roller motor, or should the motor halt for any reason, the present invention further provides audible and/or visual loss of motor power alerts.

Accordingly, a feature and advantage of the present invention is its ability to remove oil, or the like, from both the exterior and underside surfaces of an endless belt during both the ascending and descending phases of belt travel.

Another feature and advantage of the present invention is its ability to catch and collect oil, or the like, removed or scraped from the exterior and underside surfaces of an endless belt during both the ascending and descending phases of belt travel.

Still another feature and advantage of the present invention is its ability to effectively reduce overall belt wear by providing structural enhancements that cooperatively function to limit surface-to-surface contact between the underside of the belt and the roller assembly of the present invention.

Yet another feature and advantage of the present invention is its ability to effectively reduce belt-to-roller oil transfer by providing structural enhancements that cooperatively function to limit surface-to-surface contact between the underside of the belt and the roller assembly of the present invention.

Still yet another feature and advantage of the present invention is its ability to provide a belt tension adjuster.

A further feature and advantage of the present invention is its ability to provide loss of motor power alerts.

Still a further feature and advantage of the present invention is its ability to provide adjustable spring-loaded scrapers.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a grease and oil skimmer according to a preferred embodiment of the present invention, shown in use;

FIG. 2 is a side view of a grease and oil skimmer according to a preferred embodiment of the present invention, shown in use;

FIG. 3 is a side view of a grease and oil skimmer according to a preferred embodiment of the present invention, shown in use;

FIG. 4 is a side view of a grease and oil skimmer according to an alternate embodiment of the present invention;

FIG. 5A is a perspective view of a belt arrangement of a grease and oil skimmer according to an alternate embodiment of the present invention; and,

FIG. 5B is a top view of a belt arrangement of a grease and oil skimmer according to an alternate embodiment of the present invention.

### DETAILED DESCRIPTION OF THE PREFERRED AND ALTERNATIVE EMBODIMENTS

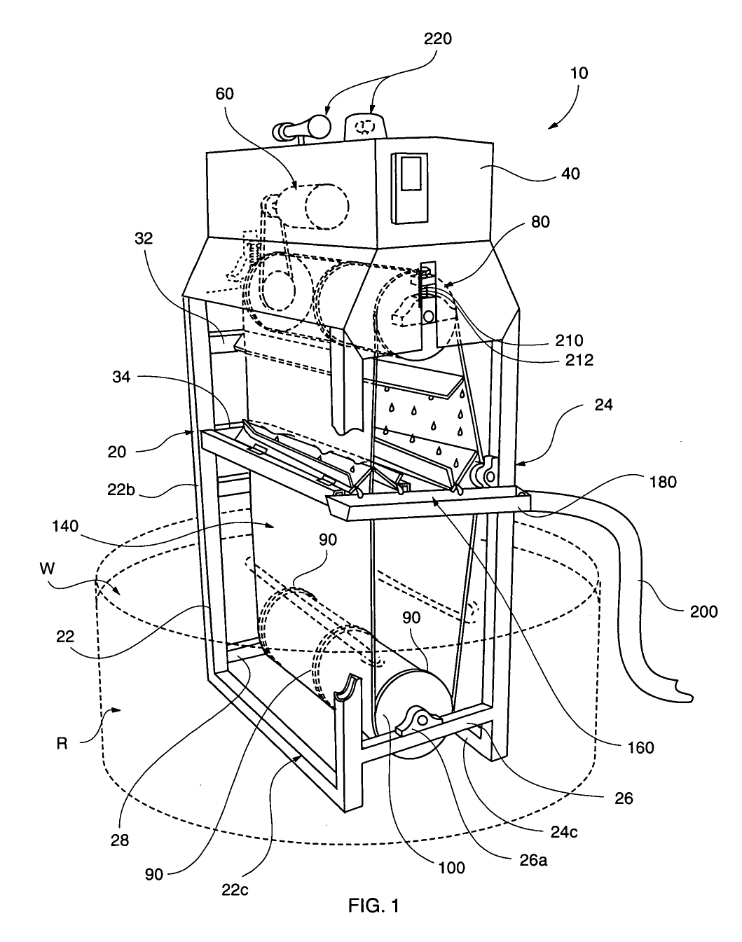

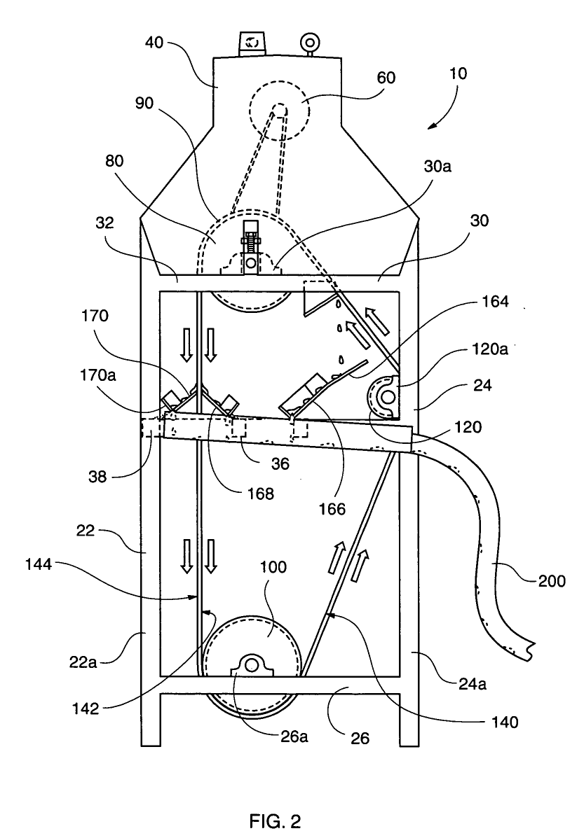

In describing the preferred and alternate embodiments of the present invention, as illustrated in FIGS. 1-5B, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in its preferred embodiment is a grease and oil skimmer 10, and method of use thereof, comprising structural support frame 20, housing 40, motor 60, drive roller 80, idler roller 100, offset roller 120, endless belt 140, scraper and collection trough assembly 160, central drainage trough 180, discharge tube 200, belt tension adjuster 210, and alarm system 220.

Specifically, structural support frame 20 is a lattice-type structure, preferably comprising upright and opposingly-disposed, U-shaped frames 22, 24, wherein frame 22 comprises first leg 22a and second leg 22b extending upwardly from base member 22c, and wherein frame 24 comprises first leg 24a and second leg 24b extending upwardly from base member 24c. Preferably disposed above and proximate to base members 22c, 24c, are lower crossbars 26, 28, which extend, respectively, between first legs 22a, 24a and second legs 22b, 24b of U-shaped frames 22, 24. Similarly, upper crossbars 30, 32 extend between the respective upper terminal ends of first legs 22a, 24a and second legs 22b, 24b of U-shaped frames 22, 24. Additionally, crossbar 34 preferably extends between second legs 22b, 24b of U-shaped frames 22, 24, proximate to upper crossbar 32.

Preferably mounted atop the upper terminal ends of legs 22a, 22b, 24a, 24b is housing 40, wherein housing 40 preferably encloses motor 60 and various electrical circuitries for operation of skimmer 10. Preferably substantially enclosed within housing 40 is drive roller 80, wherein drive roller 80 is preferably rotatably-mounted between upper crossbars 30, 32 of support frame 20 via bearing mechanisms 30a, 32a, respectively. Drive roller 80 is further preferably chain-driven or otherwise mechanically-coupled to and driven by motor 60.

Idler roller 100 is preferably rotatably-mounted between lower crossbars 26, 28 of support frame 20 via bracket-and-bearing mechanisms 26a, 28a, respectively. Additionally, preferably disposed proximate to drive roller 80 is offset roller 120, wherein offset roller 120 is rotatably-mounted between legs 24a, 24b of support frame 20 via bracket-and-bearing mechanisms 120a, 120b, respectively. Offset roller 120 functions to offset or outwardly-displace belt 140 to facilitate scraping of oil and grease from belt 140, as more fully described below.

Endless belt 140 is preferably formed from an oleophilic-hydrophobic material, such as, for exemplary purposes only, urethane, stainless steel, and the like, and is cooperatively-engaged over and around drive roller 80, offset roller 120, and idler roller 100. Preferably formed around, or otherwise disposed over, each roller 80, 100, 120 are a series of equally-spaced and raised rings 90 that provide the only contact points between each respective roller 80, 100, 120 and underside 142 of belt 140; thus, minimizing overall belt wear.

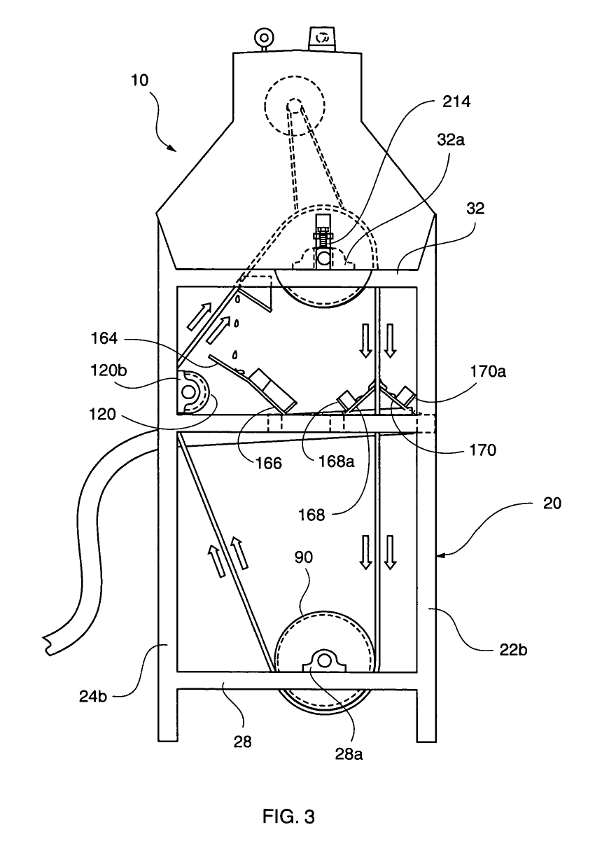

Preferably housed within, and supported by, structural support frame 20 is scraper and collection trough assembly 160. Specifically, preferably disposed below drive roller 80, and in pressure contact with underside 142 of belt 140, is ascending belt scraper 162, wherein ascending belt scraper 162 is preferably secured to upper crossbar 32 of support frame 20 and angled downwardly therefrom; thus, facilitating gravitational flow and drippage of oil, grease, and other solid particulate (i.e., waste) therefrom. Accordingly, ascending belt scraper 162 scrapes waste from underside 142 of belt 140 as belt 140 ascends (i.e., just prior to passing over drive roller 80), wherein the scraped waste preferably gravitationally falls or drips from scraper 162 onto angled catch pan 164, disposed below ascending belt scraper 162 and in fluid communication with internally-disposed collection trough 166. Catch pan 164 preferably channels the waste into collection trough 166, wherein collection trough 166 is preferably secured to crossbar 34 of support frame 20 and angled downwardly therefrom; thus, facilitating gravitational flow and drainage of scraped and collected waste from collection trough 166 into central drainage trough 180. As best illustrated in FIG. 3, central drainage trough 180 is preferably secured to legs 22a, 24a of U-shaped frames 22, 24.

Preferably further disposed below drive roller 80, and in pressure contact with underside 142 and exterior side 144 of belt 140, are inner and outer descending belt scrapers 168, 170, respectively. Specifically, inner descending belt scraper 168 is hinged to traverse bar 36, downwardly-angled and extending from crossbar 34 of support frame 20; thereby, promoting the gravitational flow and drainage of waste therefrom. Preferably, inner belt scraper 168 scrapes or removes waste from underside 142 of belt 140 as belt 140 descends (i.e., just after passing over drive roller 80). Preferably formed on scraper 168 is trough-forming wall 168a, wherein waste scraped by scraper 168 is caught by wall 168a and, thereafter, gravitationally channeled into central drainage trough 180. The hinged design of scraper 168 preferably functions to facilitate the gravitational abutment or pressured-contact of scraper 168 against underside 142 of belt 140, and further enables scraper 168 to be pivoted out of contact with belt 140 to provide access thereto.

Similarly, outer descending belt scraper 170 is hinged to traverse bar 38, downwardly-angled and extending between legs 22a, 22b of support frame 20; thereby, promoting the gravitational flow and drainage of waste therefrom. Preferably, outer belt scraper 170 scrapes or removes waste from exterior side 144 of belt 14Q as belt 140 descends (i.e., just after passing over drive roller 80). Preferably formed on scraper 170 is trough-forming wall 170a, wherein waste scraped by scraper 170 is caught by wall 170a and, thereafter, gravitationally channeled into central drainage trough 180. Similar to scraper 168, the hinged design of scraper 170 likewise functions to facilitate the gravitational abutment or pressured-contact of scraper 170 against exterior side 144 of belt 140, and further enables scraper 170 to be pivoted out of contact with belt 140 to provide access thereto.

Preferably, the respective scraping edges of scrapers 162, 168, 170 are formed from a suitable rigid plastic, such as, for exemplary purposes only, acrylic resins. However, it should be recognized that the scraping edges of scrapers 162, 168, 170 may be formed from any other suitable material, and may further be selected based upon the type of waste-skimming application. For example, when skimming oils of higher viscosity (i.e., thin oils) from wastewater, flexible, rubberized materials may provide improved oil scraping and removal capabilities over a rigid material alternative. In such alternative applications, the specific material of belt 140 (i.e., urethanes, steels, etc.) may be selected based upon the desired frictional interaction and performance characteristics with the scraper edge material.

In use, skimmer 10 would be utilized within a large bucket or reservoir R, such that idler 100 would be submersed within wastewater W deposited or otherwise channeled into reservoir R. As such, through cycling of belt 140, all waste removed from belt 140 would be deposited into central collection trough 180, from which extends discharge tube 200. Accordingly, waste drained into and expelled from discharge tube 200 is preferably suitably funneled or otherwise deposited into a containment vessel for proper disposal, handling or processing.

As normal belt wear is expected, the present invention further contemplates the application of belt tension adjuster 210, which may be utilized until replacement of belt 140 becomes necessary. Specifically, belt tension adjuster 210 preferably comprises adjustment screws 212, 214 disposed below, and in contact with, bearing mechanisms 30a, 32a of driver roller 80. Accordingly, as screws 212, 214 are turned, bearing mechanisms 30a, 32a move driver roller 80 upward or downward to thereby adjust over tension of belt 140. Alternatively, it is contemplated that tension of belt 140 may be adjusted by a fixed-position adjustable base disposed below, and in contact with, motor 60. Such a fixed-position adjustable base would enable motor 60 to be pushed or pulled into position, so that belt 140 could be adjusted; that is, one or more adjusting screws could force motor 60 away from drive roller 60 until the desired belt tension is reached.

Should there be a loss of power to motor 60, or should motor 60 halt for any reason, the present invention provides audible and/or visual loss of motor power alerts 220. Alerts 220 are preferably disposed atop housing 40 and electrically-coupled to the circuitry contained within housing 40. Alerts 220 may be wired to an alternate or back-up power supply should total systems power fail.

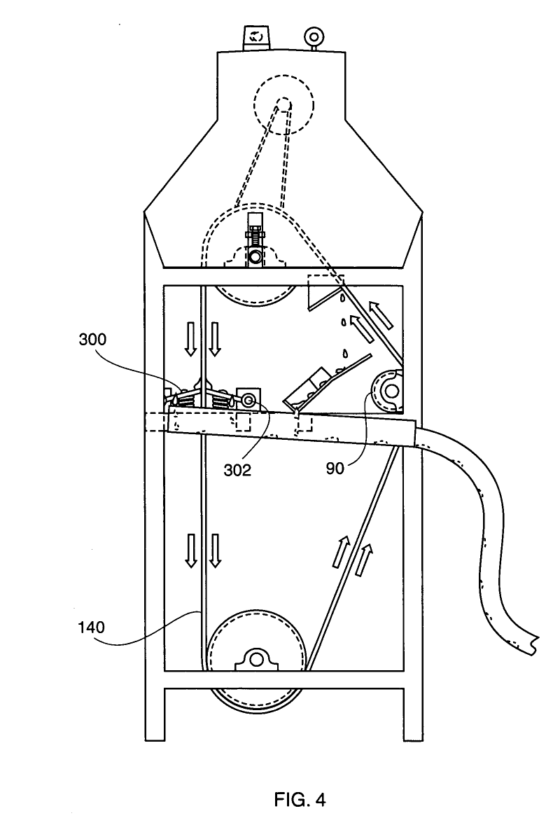

Referring now more specifically to FIG. 4, illustrated therein is an alternate embodiment of oil skimmer 10, wherein the alternate embodiment of FIG. 4 is substantially equivalent in form and function to that of the preferred embodiment detailed and illustrated in FIGS. 1-3 except as hereinafter specifically referenced. Specifically, the embodiment of FIG. 4 replaces scrapers 168, 170 with adjustable, spring-loaded belt scrapers 300, 302 operatively disposed within the present skimmer 10 to provide removal of oil and the like from belt 140 during the descending phases of belt travel, wherein adjustable, spring-loaded scrapers 300, 302 enable adjustment of pressure contact between scrapers 300, 302 and belt 140 through selection of desired spring coil gauge and wind. Increased scraper-belt pressure contact would advantageously enable removal of higher viscosity or “thinner” oils from belt 140 during operation.

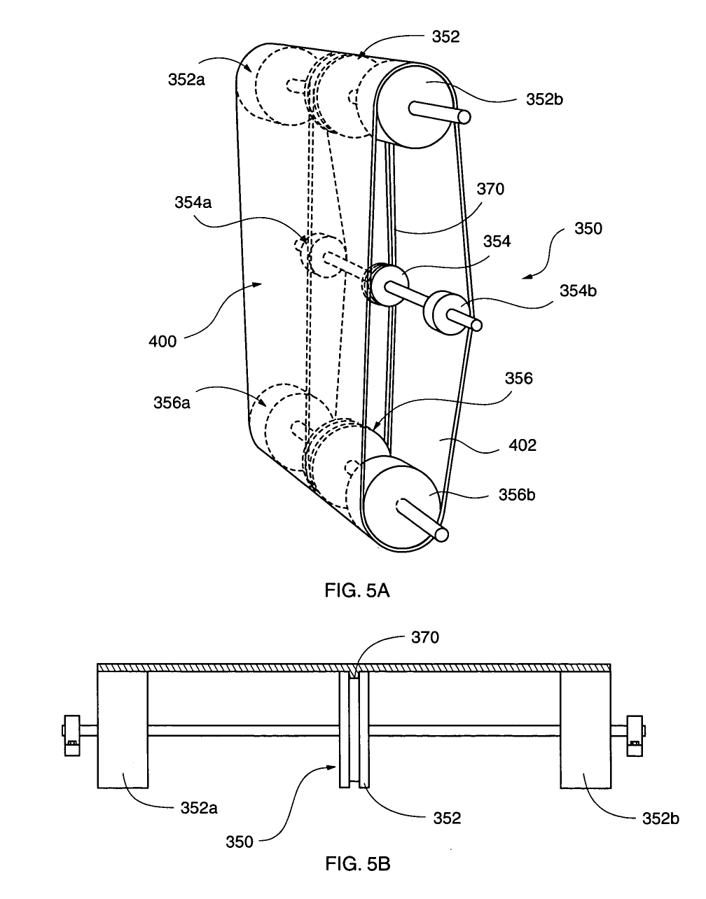

Referring now more specifically to FIGS. 5A-5B, illustrated therein is an alternate embodiment of a belt arrangement for oil skimmer 10, wherein the alternate embodiment of FIGS. 5A-5B is substantially equivalent in form and function to that of the preferred embodiment detailed and illustrated in FIGS. 1-3 except as hereinafter specifically referenced. Specifically, the embodiment of FIGS. 5A-5B replaces the preferred roller assembly (as described hereinabove) with a pulley assembly 350, and utilizes an endless stainless steel sheet-like belt 400. In such an embodiment, a rail 370 is disposed on underside 402 of belt 400, wherein plate-like drive pulley 352, offset pulley 354 and idler pulley 356 are cooperatively-engaged therewith. As such, and in view of the rigidity offered by steel belt 400, each plate-like pulley 352, 354, 356 and rail 370 would provide the only contact points with belt underside 402; thus, minimizing waste transfer, and requiring a single external scraper 450. Alternatively, in applications where a flexible, urethane belt is utilized, drive pulley 352 may be flanked by rollers 352a, 352b; offset pulley 354 may be flanked by rollers 354a, 354b; and, idler pulley 356 may be flanked by rollers 356a, 356b, to thereby offer additional peripheral belt support during scrapage of waste therefrom by external scraper 450.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A wastewater skimming apparatus, comprising:
a series of rollers;
an endless belt cooperatively-engaged around said rollers, said belt comprising an underside and an exterior side;
a belt scraper assembly; and,
a collection assembly.

2. The apparatus of claim 1, wherein said series of rollers is selected from the group consisting of a motorized drive roller, an idler roller, an offset roller, and combinations thereof.

3. The apparatus of claim 2, wherein each roller of said series of rollers comprises equally-spaced and raised rings that provide the only contact points between said rollers and said underside of said belt; thus, minimizing overall belt wear.

4. The apparatus of claim 1, wherein said belt is formed from an oleophilic material.

5. The apparatus of claim 1, wherein said belt scraper assembly comprises an ascending belt scraper disposed in pressure contact with said underside of said belt.

6. The apparatus of claim 5, wherein said ascending belt scraper is disposed at a downward angle relative to a ground surface to thereby facilitate gravitational flow and drippage therefrom of waste scraped from said belt.

7. The apparatus of claim 6, wherein said ascending belt scraper scrapes waste from said underside of said belt as said belt ascends and prior to said belt passing over a driver roller of said series of rollers.

8. The apparatus of claim 7, wherein the waste scraped from said underside of said belt gravitationally falls or drips from said ascending belt scraper onto or into said collection assembly.

9. The apparatus of claim 8, wherein said collection assembly comprises an angled catch pan disposed below said ascending belt scraper and in fluid communication with an inner collection trough disposed proximate to said underside of said belt, and wherein said catch pan channels the waste into said inner collection trough.

10. The apparatus of claim 9, wherein said inner collection trough is disposed at a downward angle relative to a ground surface to thereby facilitate gravitational flow and drainage of scraped and collected waste therefrom into a central drainage trough.

11. The apparatus of claim 1, wherein said belt scraper assembly comprises a first descending belt scraper disposed in pressure contact with said underside of said belt.

12. The apparatus of claim 11, wherein said first descending belt scraper is disposed at a downward angle relative to a ground surface to thereby facilitate gravitational flow and drippage therefrom of waste scraped from said belt.

13. The apparatus of claim 12, wherein said first descending belt scraper scrapes waste from said underside of said belt as said belt descends and prior to said belt passing over an idler roller of said series of rollers, and wherein the waste is collected by said collection assembly.

14. The apparatus of claim 13, wherein said collection assembly comprises a first trough-forming wall disposed on said first descending belt scraper, wherein waste scraped by said first descending belt scraper is caught by said first trough-forming wall and, thereafter, gravitationally channeled into a central drainage trough.

15. The apparatus of claim 14, wherein said first descending belt scraper comprises a hinged base, said hinged base functioning to facilitate the gravitational abutment or pressured-contact of said first descending belt scraper against said underside of said belt.

16. The apparatus of claim 15, wherein said hinged base of said first descending belt scraper further enables said first descending belt scraper to be pivoted out of contact with said belt to provide access thereto.

17. The apparatus of claim 16, wherein said belt scraper assembly further comprises a second descending belt scraper disposed in pressure contact with said exterior side of said belt.

18. The apparatus of claim 17, wherein said second descending belt scraper is disposed at a downward angle relative to a ground surface to thereby facilitate gravitational flow and drippage therefrom of waste scraped from said belt.

19. The apparatus of claim 18, wherein said second descending belt scraper scrapes waste from said exterior side of said belt as said belt descends and prior to said belt passing over an idler roller of said series of rollers, and wherein the waste is collected by said collection assembly.

20. The apparatus of claim 19, wherein said collection assembly comprises a second trough-forming wall disposed on said second descending belt scraper, wherein waste scraped by said second descending belt scraper is caught by said second trough-forming wall and, thereafter, gravitationally channeled into said central drainage trough.

21. The apparatus of claim 20, wherein said second descending belt scraper comprises a hinged base, said hinged base functioning to facilitate the gravitational abutment or pressured-contact of said second descending belt scraper against said exterior side.

22. The apparatus of claim 21, wherein said hinged base of said second descending belt scraper further enables said second descending belt scraper to be pivoted out of contact with said belt to provide access thereto.

23. The apparatus of claim 1, further comprising a discharge tube in communication with said collection assembly.

24. The apparatus of claim 1, further comprising a belt tension adjuster.

25. The apparatus of claim 24, wherein said belt tension adjuster comprises adjustment screws in contact with a first roller of said series of rollers, wherein rotation of said adjustment screws adjusts tension of said belt.

26. The apparatus of claim 24, where said belt tension adjuster comprises a fixed-position adjustable base disposed below, and in contact with, a motor driving a first roller of said series of rollers.

27. The apparatus of claim 1, further comprising a loss of power to motor alert.

28. The apparatus of claim 1, wherein said belt scraper assembly comprises adjustable, spring-loaded belt scrapers.

29. The apparatus of claim 1, wherein said series of rollers is selected from the group consisting of a series of pulleys, and a combination of rollers and pulleys.

30. The apparatus of claim 29, wherein said series of pulleys are cooperatively-engaged within a guide rail disposed on said underside of said belt.

31. A wastewater skimming apparatus, comprising:
an endless belt disposed around a series of rollers to thereby define an inner belt area and an outer belt area, said belt comprising an underside and an exterior side;
at least one inner belt scraper positioned within said inner belt area and disposed in pressure contact with said underside of said belt;
at least one outer belt scraper positioned within said outer belt area and disposed in pressure contact with said exterior side of said belt;
at least one inner collection trough positioned within said inner belt area and associated with said inner belt scraper; and
at least one outer collection trough positioned within said outer belt area and associated with said outer belt scraper.

32. The apparatus of claim 31, wherein said inner belt scraper scrapes waste from said underside of said belt as said belt cyclically ascends.

33. The apparatus of claim 31, wherein said inner belt scraper scrapes waste from said underside of said belt as said belt cyclically descends.

34. The apparatus of claim 31, wherein said outer belt scraper scrapes waste from said exterior side of said belt as said belt cyclically descends.

35. A method for removing oil, grease, fat, solid particulate and similar waste materials from a body of water, said method comprising the steps of:
a. cycling an endless belt through the body of water to thereby draw the waste onto an underside and an exterior side of said belt;
b. scraping the waste from said underside and said exterior side of said belt as said belt cyclically ascends and descends.
